(19) United States
(12) Patent Application Publication
(10) Pub. No.: US 2003/0130862 A1
(43) Pub. Date: Jul. 10, 2003

(54) Method and apparatus for establishing a distribution network

(76) Inventors: Edith H. Stern, Yorktown Heights, NY (US); David P. Greene, Ossining, NY (US); Barry E. Willner, Briarcliff Manor, NY (US); Philip Shi-Lung Yu, Chappaqua, NY (US)

Correspondence Address: BUCKLEY, MASCHOFF, TALWALKAR, & ALLISON, 5 ELM STREET, NEW CANAAN, CT, 06840, US

(21) Appl. No.: 10/042,788

(22) Filed: Jan. 9, 2002

(51) Int. Cl. G06F 17/60

(52) U.S. Cl. 705/1

(57) ABSTRACT

A system, method, apparatus, and computer program code for distribution of “soft goods” and other forms of electronic or digital content via a distribution network includes motivating a distributor or other party in the network to establish one or more additional distributors in the network. Motivation can be provided to a distributor to expand the distribution network by providing an incentive, compensation or other benefit to a distributor that helps establish another distributor in a network or searches for one or more distributors that have characteristics or meet requirements associated with the network.

### FIELD OF THE INVENTION

The present invention relates to a method and apparatus for establishing and growing a distribution network and, more particularly, embodiments of the present invention relate to methods, apparatus, means, and computer program code for managing a network for the distribution of content in digital or other electronic format and promoting growth and stability of the network.

### BACKGROUND OF THE INVENTION

Networks have been established for the distribution of many different kinds of products. For example, file sharing via peer-to-peer networks is becoming increasingly popular. Such networks often are used to distribute products in digital or other electronic form, such as software, music, movies, streaming video, e-books, etc. A network may use the Internet or World Wide Web (“Web”) to distribute products between distributors and to recipients of the products.

One problem associated with file sharing and other distribution networks is the need to, and difficulty of, enrolling or adding additional distributors in the network. Moreover, locating potential distributors can be difficult.

It would be advantageous to provide a method and apparatus that overcame the drawbacks of the prior art. In particular, it would be desirable to provide a method and apparatus that facilitated distribution of products or other content in electronic or digital form via a network. In addition, it would be desirable to provide a method and apparatus for establishing the network and motivating one or more distributors in the network to locate and enroll additional distributors for the network. Furthermore, it would be desirable to provide a method and apparatus in which desirable characteristics for one or more distributors are ascertained and current distributors in the network may locate or solicit potential distributors for the network.

### SUMMARY OF THE INVENTION

Embodiments of the present invention provide a system, method, means, apparatus, and computer program code for distribution of content via a distribution network. According to embodiments of the present invention, a distributor of content may be compensated or may receive a benefit for establishing one or more additional distributors in the network. Typically, the content will be “soft goods” or products, data, or other content that can be delivered or stored in a digital or other electronic format. For example, such “soft goods” or content may be or include software, music or sound files, streaming video, advertising, educational materials, entertainment, images or movies, e-books, etc.

As one example, a filmmaker may want to establish a distribution network to distribute a short science fiction film. The filmmaker may solicit one or two science fiction fans to act as distributors of the film in digital format over the Web. For each additional distributor that an original two distributor establishes, the filmmaker may provide a benefit to the original distributor.

Additional objects, advantages, and novel features of the invention shall be set forth in part in the description that follows, and in part will become apparent to those skilled in the art upon examination of the following or may be learned by the practice of the invention.

According to embodiments of the present invention, a method for establishing a distribution network may include establishing a first distributor of content capable of distributing the content via transmission of an electronic signal; and providing a first benefit to the first distributor as a result of the first distributor establishing a second distributor of the content. In another embodiment, a method for participating in a distribution network may include establishing at least one distributor of the content; and receiving a benefit based, at least in part, on the establishing at least one distributor of the content. In a further embodiment, a method for maintaining a distribution network may include determining a requirement of a network for distribution of content, wherein the content is in electronic form and the network includes at least one distributor of the content; determining at least one desired attribute for a distributor of the content, wherein the attribute is based, at least in part, on the requirement; and providing an indication of the desired attribute.

According to embodiments of the present invention, a system for establishing at least one distributor of content may include a memory; communication port; and a processor connected to the memory and the communication port, the processor being operative to: establish a first distributor of content capable of distributing the content via transmission of an electronic signal; and provide a first benefit to the first distributor as a result of the first distributor establishing a second distributor of the content. In another embodiment, the processor instead may be operative to establish at least one distributor of the content; and receive a benefit based, at least in part, on the establishing at least one distributor of the content. In a further embodiment, the processor may instead be operative to determine a requirement of a network for distribution of content, wherein the content is in electronic form and the network includes at least one distributor of the content; determine at least one desired attribute for a distributor of the content, wherein the attribute is based, at least in part, on the requirement; and provide an indication of the desired attribute.

According to embodiments of the present invention, an apparatus for rewarding a distributor of content may include means for determining a first distributor of content capable of distributing the content via transmission of an electronic signal; and means for sending a first benefit to the first distributor as a result of the first distributor establishing a second distributor of the content. In another embodiment, an apparatus may include means for determining at least one distributor of the content; and means for sending a benefit based, at least in part, on the establishing at least one distributor of the content. In a further embodiment, an apparatus may include means for identifying a requirement of a network for distribution of content, wherein the content is in electronic form and the network includes at least one distributor of the content; means for identifying at least one desired attribute for a distributor of the content, wherein the attribute is based, at least in part, on the requirement; and means for sending an indication of the desired attribute.

According to embodiments of the present invention, a computer program product in a computer readable medium for rewarding a distributor of content may include first instructions for determining a first distributor of content capable of distributing the content via transmission of an electronic signal; and second instructions for sending a first benefit to the first distributor as a result of the first distributor establishing a second distributor of the content. In another embodiment, a computer program product in a computer readable medium may include first instructions for determining at least one distributor of the content; and second instructions for sending a benefit based, at least in part, on the establishing at least one distributor of the content. In a further embodiment, a computer program product in a computer readable medium may include first instructions for identifying a requirement of a network for distribution of content, wherein the content is in electronic form and the network includes at least one distributor of the content; second instructions for identifying at least one desired attribute for a distributor of the content, wherein the attribute is based, at least in part, on the requirement; and third instructions for sending an indication of the desired attribute.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF THE DRAWINGS

The accompanying drawings, which are incorporated in and form a part of the specification, illustrate the preferred embodiments of the present invention, and together with the descriptions serve to explain the principles of the invention.

FIG. 1 is a flowchart of a first embodiment of a method in accordance with the present invention;

FIG. 2 is an illustration of distribution network usable with the methods of FIG. 1;

FIG. 3 is a flowchart of a second embodiment of a method in accordance with the present invention;

FIG. 4 is a flowchart of a third embodiment of a method in accordance with the present invention;

FIG. 5 is another illustration of the distribution network of FIG. 2, the network being usable with the methods of FIGS. 1 and 3-4;

FIG. 6 is a block diagram of system components for an embodiment of a distribution device usable with the methods of FIGS. 1 and 3-4;

FIG. 7 is an illustration of a representative network information database of FIG. 6;

FIG. 8 is an illustration of a representative distributor information database of FIG. 6;

FIG. 9 is an illustration of a representative content information database of FIG. 6;

FIG. 10 is an illustration of a representative user information database of FIG. 6; and

FIG. 11 is an illustration of a representative user device information database of FIG. 6.

### DETAILED DESCRIPTION

Applicants have recognized that there is a need for systems and methods that allow a network to distribute “soft goods” and other forms of electronic or digital content. In addition, applicants have recognized that there is a need to provide a method for altering or expanding the distribution network and for motivating a distributor in the network to establish or locate one or more additional distributors in the network.

There are lots of content providers that may want to establish distribution networks. For example, a freelance software developer may want to establish a distribution network for a short period of time to distribute copies of a game that the developer has created. A publisher may want to establish a distribution network to sell e-books. While the software developer and the publisher may use conventional or already established distribution mechanisms (e.g., bookstores, software stores), they also might want to set up distribution networks on an ad-hoc basis that use the skills and contacts of other channels, people, etc.

Embodiments of the present invention provide such capabilities, by providing an incentive, compensation or other benefit to a distributor that helps establish another distributor in a network or searches for one or more distributors that have desirable characteristics or meet requirements associated with the network. These and other features will be discussed in further detail below, by describing a system, individual devices, and processes according to embodiments of the invention.

Process Description

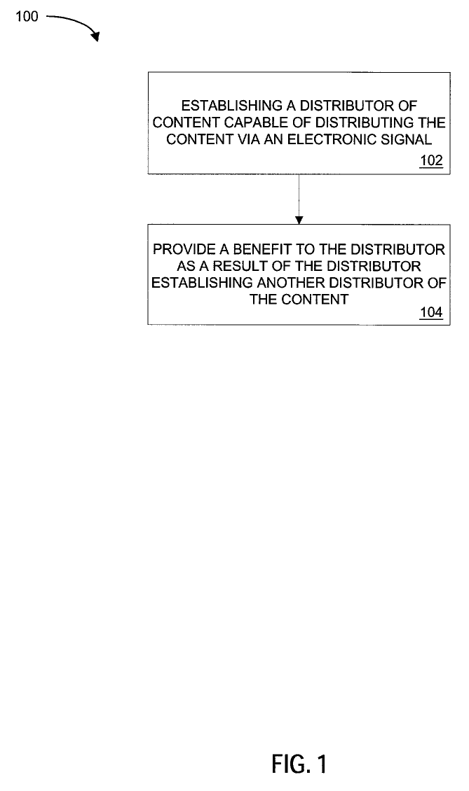

Reference is now made to FIG. 1, where a flow chart 100 is shown which represents the operation of an embodiment of the present invention. The particular arrangement of elements in the flow chart 100 is not meant to imply a fixed order to the steps; embodiments of the present invention can be practiced in any order that is practicable. In some embodiments, some or all of the steps of the method 100 may be performed or completed by a server, user device and/or another device, as will be discussed in more detail below.

The method 100 is particularly well suited for use with the distribution of content that is in digital or other electronic format. For example, the content provided via a distribution network or by a distributor may be or include educational information, an advertisement, a survey or question, an animation, a sound file, a music file, a movie file, software, a video clip, steaming video, a multimedia file, an image, text material, rich media, streaming audio, real-time information feed, etc.

Processing begins at a step 102 during which at least one distributor of content is established. Preferably, the distributor(s) established during the step 102 are capable of providing, transmitting or otherwise distributing the content via an electronic signal. There are many ways a distributor of content may be established. For example, a content developer may recruit a party (e.g., individual, Web site, company) to act as distributor of its content. As another example, a party may request to be a distributor or agree to act as a distributor.

In some embodiments, information regarding one or more distributors may be found or stored in a distributor information database. Similarly, information regarding one or more distribution networks may be found or stored in a network information database. Likewise, information regarding content and/or one or more content providers may be found or stored in a content and/or content provider database.

In a further example, a provider of content may allow a person to sign up to be a distributor online (e.g., via a Web site operated by the provider) in which the provider and the person execute an agreement for the person to act as a distributor of content. The provider may then provide the content and/or an identifier of the content to the person and later may update the content, provide new content to the person, etc. The provider may provide the content to the person as part of an email message, FTP (File Transfer Protocol) transmission, etc. or the person may retrieve the content by accessing one or more Web sites, databases, etc. on which the content is stored. The content may be provided to or retrieved by the distributor in an encrypted form, thereby requiring the distributor to retrieve, receive or otherwise obtain a password, key, unlock code, etc. from the provider of the content in order to decrypt the content.

In some embodiments, the step 102 or establishing a distributor of content may be or include one or more of the following: receiving a request from a distributor to act as a distributor of the content; registering a distributor as part of a distribution network for the content; receiving approval from a provider of the content to allow a party or device to act as a distributor of the content; granting a license to a party to act as a distributor of the content; providing data to a distributor indicative of a benefit available to the distributor; providing a notification of availability of a benefit available to a potential distributor if the distributor establishes another distributor; etc.

In some embodiments, the distributor established during the step 102 may be notified of the benefit or the availability of the benefit as part of the step 102. In other embodiments, the distributor may be notified of the benefit upon receiving content or prior to agreeing to become a distributor.

In some embodiments, a newly established distributor, a party establishing the distributor, or some other party may send out a notification regarding the establishment of a distributor to potential customers or recipients of content that can be obtained from, or distributed by, the new distributor, other potential distributors, current distributors, etc. Such a notification may be in any form or format, including, but not limited to, a HTTP (Hypertext Transfer Protocol), HTML (Hypertext Mark-up Language) or FTP transmission, XML (Extensible Mark-up Language) feed, email message, instant message communication, facsimile or radio transmission, telephone call, beeper signal, or other type or form of electronic signal or communication.

In some embodiments, the distributor established during the step 102 may provide benefits and/or content to additional distributors, who may themselves provide the content and/or an identifier of the content and/or benefits to even further distributors.

During a step 104, a benefit is provided to the distributor established during the step 102 when the distributor establishes another distributor of the content. In some embodiments, a distributor that is establishing a new distributor may do so in a manner similar to that discussed above in reference to the step 102. A benefit may be or include many things such as, for example, a monetary or non-monetary amount, frequent flyer miles, long distance calling minutes, Internet access, rebates or discounts on products, free products, coupon, free or discount services, points redeemable for or usable to acquire other benefits, additional bandwidth for transmissions, etc.

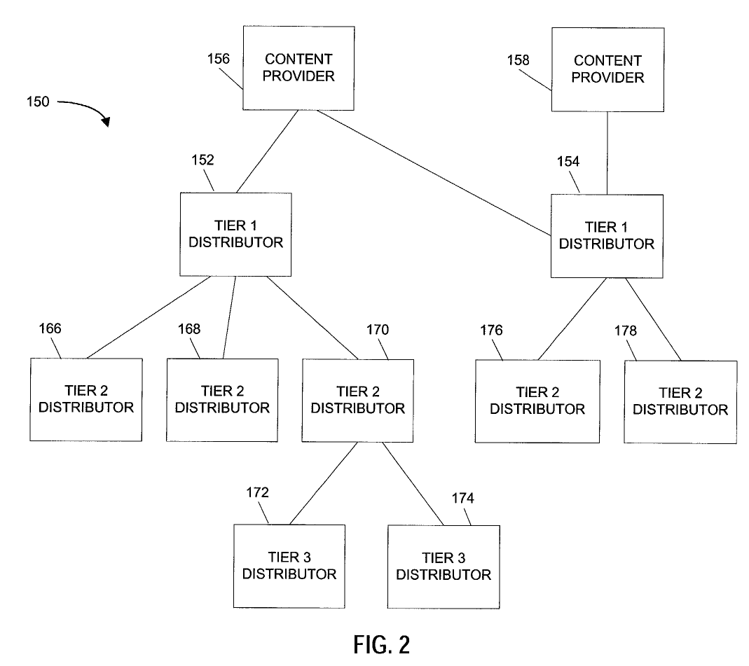

In some embodiments, a network of distributors may be set up in a tiered fashion, as illustrated by the system 150 of FIG. 2. In the system 150, distributors 152 and 154 may distribute content from two content providers 156, 158 to one or more additional distributors and/or purchasers (i.e., recipients) of the content. The content provided by the content provider 156 may be different from the content provided by the content provider 158. For example, content from the content provider 156 may be word processing software while the content from the content provider 158 may be electronic or digital versions of movies.

As illustrated by the system 150 of FIG. 2, the distributor 154 distributes content from both of the content providers 156, 158 while the distributor 152 distributes content only from the content provider 156. The distributor 152 may provide the content from the content provider 156 to purchasers of the content and, as illustrated by the system 150, may provide the content to distributors 166, 168 and 170.

In some embodiments, the distributor 152 may be identified or labeled as a tier one distributor in relation to the content provider 156 since the distributor 152 is in communication with the content provider 156 while the distributors 166, 168, 170 may be identified or labeled as a tier two distributor in relation to the content provider 156 since they are not in direct contact with the content provider 156 but instead go through the distributor 152 to received content from the content provider 156. Similarly, distributors 172, 174 may be tier three distributors in relation to the content provider 156. The distributor 154 acts as a tier one distributor in regard to the content provider 156 and also in regard to the content provider 158. Similarly, distributors 176 and 178 act as tier two distributors with regard to the content provider 156 and to the content provider 158. The distributors 176, 178 may receive content from the distributor 154 as opposed to the content providers 156, 158. The use of the term “tier” for purposes of the present invention is used only for convenience and ease of explanation and should not be construed as limiting the present invention in any way. A distributor may act as a mirror of another distributor.

The distributor 152 may receive a benefit as a result of the step 104 for establishing one or more of the distributors 166, 168, 170. Similarly, the distributor 170 may receive a benefit for establishing one or more of the distributors 172, 174. The distributor 152 also may receive a benefit for the distributor 170 establishing one or both of the distributors 172, 174, although it may be less than the benefit that the distributor 170 receives. The distributor 152 may receive additional benefits if one or more of the distributors 166, 168, 170, 172, 174 themselves establish additional distributors.

By providing benefits to distributors for establishing other distributors, distributors are motivated to help grow and develop a distribution network. In situations where a distribution network is or includes a peer-to-peer network, a content provider may find it difficult to locate distributors for its content while distributors already in the network may have an easier time since they are dealing directly with potential and actual recipients of the content that the distributors may be able to convince to become distributors. Different benefits may be provided to different tiers, for different content, to different distributors, etc.

In some embodiments, a distributor might be in a different relationship with different content providers. For example, a distributor might be a tier one distributor for purposes of one content provider and a tier two distributor for a different content provider. A content provider may be associated with more than one distribution network, and vice versa. Similarly, a content provider may be associated with more than one distributor, and vice versa. In some embodiments, a message or other communication may be received from the distributor established during the step 102 that the distributor has established another distributor.

For the system 150 disclosed in FIG. 2, distributors 152, 166, 168, 170, 172 and 174 form a distribution network for the content provider 156 while the distributors 154, 176 and 178 form a distribution network for the content provider 156 and for the content provider 158. In some embodiments, complex distribution arrangements may be established where not all distributors in a network are distributing the same content. For example, the distributor 176 might distribute content for only one of the content providers 156, 158 while the distributor 178 distributes content for the content provider 158 or for both of the content providers 156, 158.

In some embodiments, a network manager may be included in the apparatus 150 to implement the method 100, monitor the networks in the apparatus 150, or determine characteristics of the network, distributors, content providers, etc. A network manager also may function as a distributor or a content provider. Some networks may include more than one network manager. For example, a distribution network may include a network manager for each geographic region (e.g., North America, South America, Europe) covered by the distribution network.

In some embodiments, a network or one or more distributors or other parties in the network may shift content distribution, storage, etc. among distributors to even load throughout the network, reduce latency, availability, customer satisfaction, usage, and/or reliability problems, balance customer demands or requests or purchases for content, etc. A distributor may volunteer to change the content it provides, the customers or other distributors to which it provides content, etc. or such a change may be initiated by a network manager, content provider, or other party. A distributor in a network may be responsible for monitoring performance, customer satisfaction, technical capabilities, etc. for distributors which it establishes, for which it is in communication, for which it receives or provides benefits or content, etc. The distributor may need to provide information regarding such performance, customer satisfaction, etc. to a network manager, content provider, etc.

In some embodiments, a benefit to a distributor may be based, at least in part, on one or more of the following: an amount per distribution of content by the distributor to another distributor, to a recipient of the content, etc.; an amount per distribution of content by another distributor; storage capacity of the distributor; availability or reliability of the distributor; bandwidth of the distributor or another distributor; physical or topological location of the distributor; availability of the distributor; amount of access of the distributor by potential recipients of the content; buying history of content from the distributor; demographic profile or characteristics (e.g., age, occupation, income level, gender, residence) of customers of the distributor or recipients of the content, an amount (e.g., number or size of bytes, files, products) or type (e.g., streaming video, rich media, text) of content distributed by a distributor, etc. In some embodiments, the benefit to a first distributor may be based on the capabilities, actions, content distributions, amount or type of content distributions, customers, etc. of another distributor established by the first distributor.

In some embodiments, the step 104 or providing a benefit to a distributor may be or include one or more of the following: providing an indication to the distributor of the benefit; providing an instruction to a party to provide the benefit to the distributor; providing instructions to the distributor regarding how the distributor can receive the benefit; applying the benefit during a transaction (e.g., purchase of content) by the distributor; etc.

In some embodiments, the method 100 may include providing content to the distributor established during the step 102. As previously discussed above, the content may be provided in an encrypted or encoded format. The content may be provided in or as part of a notification sent to the distributor, which can be in any form or format. Alternatively, the content may be provided to the distributor by sending data (e.g., URL, link, electronic address) to the distributor that the distributor can use to retrieve, download or otherwise access the content from a location (e.g., Web site, database, other distributor). In some embodiments, the method 100 may include receiving an acknowledgement or confirmation of a receipt of content by a distributor or an intermediary party.

In some embodiments, providing content to a distributor may be or include one or more of the following: instructing another distributor network to provide the content to the first distributor; allowing the distributor to retrieve the content; providing data to the distributor indicative of a location where the content is located or can be retrieved; providing a key to the distributor that enables use, decryption, etc. of the content; emailing the content to the distributor; etc.

A party implementing the method 100 may be a distributor, content provider, network manager or other party. In some embodiments, a party implementing the method 100 may receive the content from a content provider or other party, store the content, update the content, modify the content, etc.

In some embodiments, the method 100 may include determining a characteristic or other attribute desired for a new distributor of the content and notifying the distributor established during the step 102. The distributor may receive a benefit for locating or establishing another distributor that has the desired attribute. An attribute may be or include geographic location, network or topological location, storage capacity, bandwidth, availability, accessibility, operational status, uptime percentage, etc. In some embodiments, the distributor itself may have or develop the desired attribute and receive a benefit for doing so.

In some embodiments, a party implementing the method 100 may provide a notification (e.g., email message, instant message communication) informing potential or actual distributors of the availability of the benefit. The notification may occur prior to the step 102 and/or 104.

In some embodiments, a party implementing the method 100 may receive payment for the content from a recipient (e.g. customer) of the content, a distributor established by the party, etc. The party also may provide payment for the content to the distributor, content provider, etc. from which the party received the content.

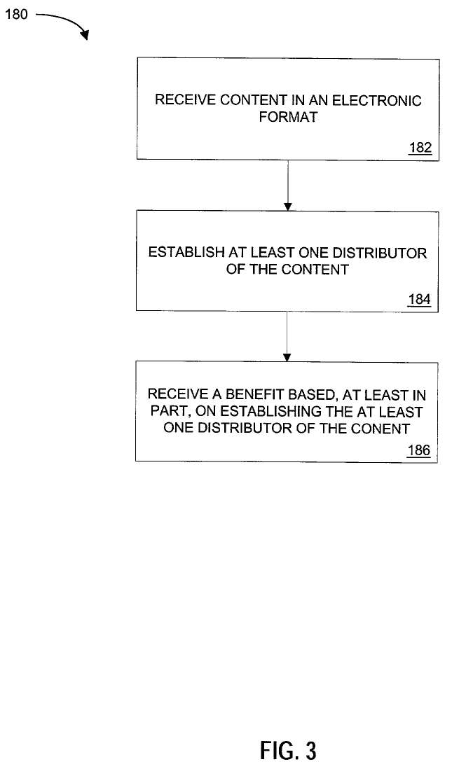

Reference is now made to FIG. 3, where a flow chart 180 is shown which represents the operation of a second embodiment of the present invention. The particular arrangement of elements in the flow chart 180 is not meant to imply a fixed order to the steps; embodiments of the present invention can be practiced in any order that is practicable. In some embodiments, some or all of the steps of the method 180 may be performed or completed by a server, user device and/or another device, as will be discussed in more detail below. The method 180 is particularly suited for implementation by a distributor in a network.

Processing begins at a step 182 during which a distributor receives content that the distributor may later provide to purchasers, other distributors, etc. The content received during the step 182 may come from another distributor, a content provider, etc. The distributor receiving the content may be an established part of a distribution network or a new distributor in a distribution network.

In some embodiments, the step 182 or receiving content may be or include one or more of the following: receiving content via transmission of an electronic, wireless or other signal; receiving content from another distributor of the content; receiving the content from a content provider; receiving data (e.g., URL, link, electronic address) indicative of a location where the content is located or retrievable; receiving a key or other password that enables decryption, use, storage, transmission, etc. of the content, etc.

After receiving the content during the step 182, a distributor may then transmit it to an end user, purchaser or other recipient and collect compensation from the end user, purchaser or other recipient. The distributor may remit all or part of the compensation to a network manager, content provider or other distributor.

In some embodiments, the step 182 may be optional. That is, an entity may receive a benefit for establishing a distributor of content even if the entity is not itself a distributor of the content.

During a step 184, at least one new distributor of the content is established. The step 184 is similar to the step 102 previously discussed above. In some embodiments, the step 184 or establishing a distributor of content may be or include one or more of the following: receiving a request from a distributor to act as a distributor of the content; registering a distributor as part of a distribution network for the content; receiving approval from a provider of the content to allow a party or device to act as a distributor of the content; granting a license to a party to act as a distributor of the content; providing data to a distributor indicative of a benefit available to the distributor; providing a notification of availability of a benefit available to a potential distributor if the distributor establishes another distributor; etc.

In some embodiments, the step 184 or the method 180 may include providing content to a newly established distributor. Providing content to a distributor may be or include instructing another party in a distribution network to provide the content to the distributor; provide an identifier or other description of the content to the distributor; allowing the distributor to retrieve, download, etc. the content; providing data (e.g., URL, link, electronic address) to the distributor indicative of a location where the content is located or can be retrieved; providing a key to the distributor that enables use, decryption, etc. of the content; etc.

In some embodiments, a party implementing the method 180 may inform another party (e.g., content provider, network manager, other distributor) that the party has established a new distributor. The party may then receive a benefit from the other party for establishing the new distributor.

During a step 186, a benefit is received based, at least in part, on the establishment of the new distributor during the step 184. In some embodiments, the step 186 may be or include receiving an indication of a location of the benefit; receiving a description of the benefit; receiving instructions how to receive, locate, retrieve, etc. the benefit, etc. A previously discussed above, a benefit may a monetary amount, a non-monetary amount, coupon, discount, rebate, etc.

In some embodiments, a party implementing the method 180 may receive a notification (e.g., email message, instant message communication) informing the party of the availability of the benefit. The notification may occur prior to the step 182, 184 and/or the step 186. The party also may provide a similar notification to other potential distributors the party is trying to establish.

In some embodiments, a party implementing the method 180 may provide content and/or a benefit to another distributor in a distribution network (e.g., a distributor established during the step 184). As other possible variations of the method 180, a party may determine a desired attribute of a new distributor for a network or receive information regarding a desired attribute for a new distributor. The party may use the information during the step 184 and/or pass along the information to other parties. In some embodiments, a distributor may determine an attribute of the content received during the step 182 for use in determining or setting an benefit, establishing a new distributor for the content, determining a requirement or desired attribute of the content, etc.

In some embodiments, a party implementing the method 180 may receive payment for the content from a recipient of the content, a distributor established by the party, etc. The party also may provide payment for the content to the distributor, content provider, etc. from which the party received the content.

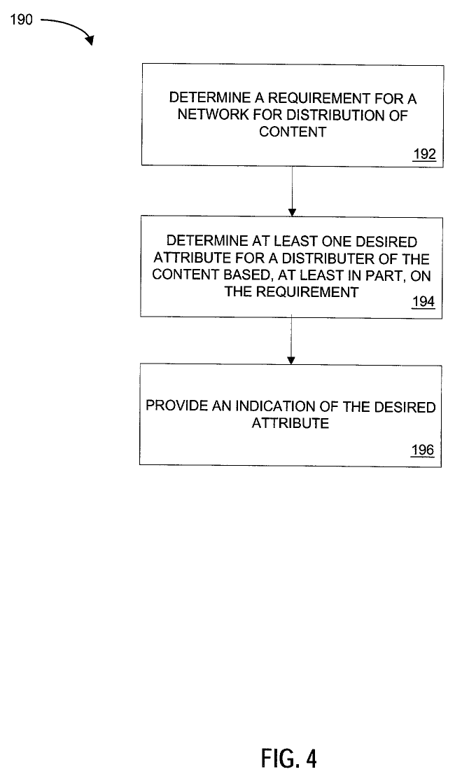

Reference is now made to FIG. 4, where a flow chart 190 is shown which represents the operation of a third embodiment of the present invention. The particular arrangement of elements in the flow chart 190 is not meant to imply a fixed order to the steps; embodiments of the present invention can be practiced in any order that is practicable. In some embodiments, some or all of the steps of the method 190 may be performed or completed by a server, user device and/or another device, as will be discussed in more detail below. The method 190 is particularly suited for an entity or device (referred to herein as a “manager”) that monitors or maintains a network on behalf of one or more distributors or even a content provider. In some embodiments, the method may include some or all of the variations discussed above in regard to the methods 100 and 180.

Processing begins at a step 192 during which a requirement for a distribution network is determined. In some embodiments, the network may be used to distribute content in electronic or digital format. The network may include one or more distributors and zero or more content providers. In some embodiments, the network may be organized along distributor tiers similar to the system 150 illustrated in FIG. 2.

The requirement determined during the step 192 may be a current requirement or a future or expected requirement. For example, in some embodiments a requirement may be directed to a current, future or expected requirement for a network or one or more distributors in the network to respond to requests for content; a current, future or expected requirement for a network or one or more distributors in the network to provide content to at least one recipient; a current, future or expected requirement for a network or one or more distributors in the network to store, update, maintain, receive, etc. content; a current, future or expected delivery or storage requirement associated with content; etc.

As additional examples, in some embodiments a requirement may be directed to a minimum level of ability of a distributor in a network to transmit store, update, maintain, etc. content; a minimum percentage of availability of a distributor in a network; an affiliation of the distributor with a designated organization; a minimum mobility of the distributor; a minimum processing capability of the distributor; a designated hardware configuration; a designated software configuration; a minimum reliability level; a minimum amount of accessibility of a distributor in a network; a minimum storage capability of a distributor in a network; a specific physical location of a distributor in a network; a specific topological location of a distributor in a network; a specific configuration of hardware used by a distributor in a network; a minimum transmission capability of a distributor in a network; a minimum satisfaction level associated with at least one recipient of content from a distributor in a network; a minimum level of ability by a distributor in a network to respond to requests from potential recipients of content; a minimum number of distributions of content by a distributor in a network; etc.

As another example, a network may monitor its overall load and the load of one or more distributors or other points in the network. Loads at different points and the network may vary as content distributed via the network is changed, added, deleted, etc., the amount and/or type of advertising provided by the distribution network regarding the content is changed, distributors take on or cease providing additional functions (e.g., functioning as application servers or databases), etc. Optimization techniques, models, heuristics may be used to monitor, determine or estimate network load or other network characteristics.

There are many ways in which a requirement might be determined. For example, a network or manager may ascertain a requirement from historical trends, receive a request, notification or inquiry from a distributor or content provider regarding a requirement, estimate a future network requirement and ability of the network to meet or satisfy the requirement, receive a notification of a requirement from a current or potential customer or other recipient of content distributed via the network, etc.

In some embodiments, the step 192 or determining a requirement for a network may be or include one or more of the following: evaluating the network's current, future or expected ability to respond to requests for content; evaluating the network's current, future or expected ability to provide content to at least one recipient; evaluating the network's current, future or expected ability to store, update, maintain, deliver, receive, etc. content; determining a delivery or storage requirement associated with content; determining ability of a distributor in the network to store, receive, update, transmit, etc. content; receiving an indication of the requirement from a distributor of the content (e.g., the distributor provides a warning regarding expected load requirements for the distributor or network or expected delivery requests for content provided by the distributor); receiving an indication of the requirement from a recipient of content (e.g., a recipient indicates that delivery of content from a particular distributor was too slow or failed to meet delivery guidelines specified by the recipient, distributor, a content provider, etc.); monitoring change in an operational characteristic of a distributor in the network (e.g., monitoring ability of the distributor to meet expected load or delivery conditions); determining availability, accessibility, storage capacity, physical location, network topological location, reliability, organization affiliation, bandwidth, hardware configuration, transmission capability, software configuration, etc. of a distributor of the content; determining a satisfaction level associated with at least one recipient of content from a distributor and ascertaining if the satisfaction level is appropriate or meets a designated minimum threshold; monitoring distributions of content by a distributor; determining a number of requests for delivery of content received by a distributor of the content within a time period and monitoring the distributor's ability to provide the content in a timely manner; etc.

During a step 194, a desired attribute is determined for a distributor based, at least in part, on the requirement determined during the step 192. For example, if a requirement is determined during the step 192 that a network needs a distributor located in Canada, the attribute determined during the step 194 may be a geographic location of a distributor in Canada. As another example, if a network will be asked to distribute double the amount of content that it previously distributed, the attribute determined during the step 194 may be regarding storage capacity of a distributor. As illustrated by these examples, the attribute determined during the step 194 helps a network meet a current, future or expected requirement associated with the network. In some embodiments, the attribute determined during the step 194 may be or relate to one or more of the following: a minimum operational characteristic; a minimum availability to a potential recipient of content; a minimum accessibility by a potential recipient of content; a minimum storage capability; a physical location; a topological location; a minimum transmission capability; a minimum bandwidth; an affiliation with a designated organization; a minimum customer base size; a minimum mobility requirement; a minimum processing capability; a designated hardware configuration; a designated software configuration; a minimum reliability level; etc.

In some embodiments, the step 194 or determining at least one desired attribute of a distributor of content based, at least in part, on a current, future or expected requirement associated with the network may be or include determining an attribute that will help the network meet or satisfy the requirement if a distributor having the attribute is added to the network or determining an attribute that will help the network meet the requirement if a distributor already in the network develops the attribute.

During a step 196, a notification or other indication regarding the attribute determined during the step 194 is provided to a distributor in the network or some other party. The notification may be in any form or format. In some embodiments, a benefit may be provided to a party that establishes a distributor that satisfies the attribute or develops the attribute. Thus, the notification provided during the step 196 may include information regarding a benefit available for a party that establishes a new distributor for the network that satisfies the attribute and/or a benefit available to a distributor in the network that develops or otherwise acquires the attribute. Thus, a benefit system can be used to motivate current distributors or other parties involved in a network to establish additional capabilities or other distributors.

In some embodiments of the methods disclosed herein, a party may receive a payment for managing or maintaining a distribution network, distributing content via a network, etc.

System

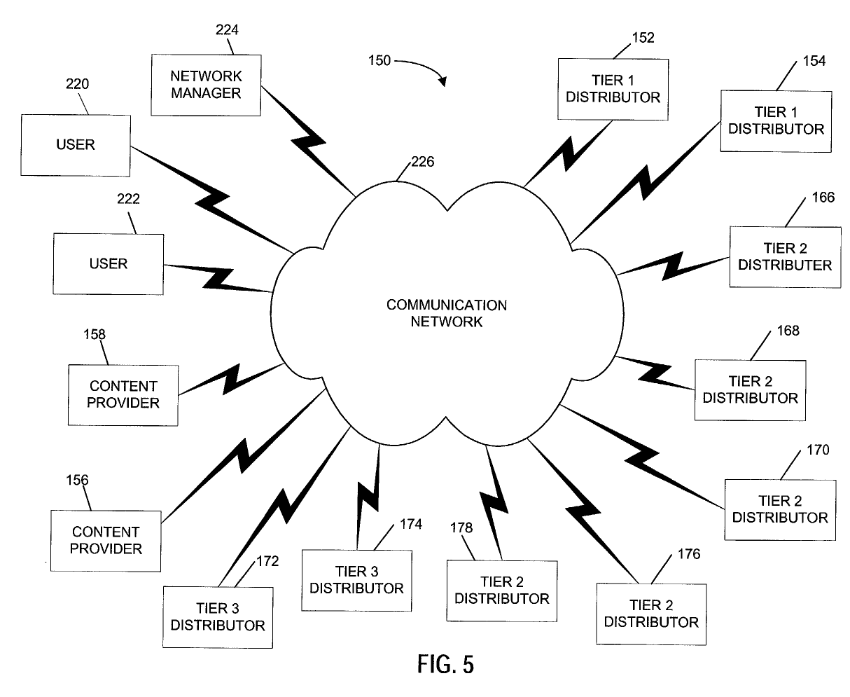

Now referring to FIG. 5, another illustration of the apparatus of system 150 usable with the methods disclosed herein is illustrated. One or more user or client devices 220, 222 and/or network managers 224 may communicate directly or indirectly with one or more of the distributors in the system 150 via a computer, data, or communications network 226. A network manager also may be a distributor or content provider.

The network manager 224 may implement or host a Web site. The network manager 224 can comprise a single device or computer, a networked set or group of devices or computers, a workstation, etc. Similarly, a distributor can comprise a single device or computer, a networked set or group of devices or computers, a workstation, etc. Likewise, a content provider can comprise a single device or computer, a networked set or group of devices or computers, a workstation, etc. The use, configuration and operation of network managers and distributors will be discussed in more detail below.

The user or client devices 220, 222 preferably allow entities to interact with the apparatus 150, receive content from distributors, provide payment for content, etc. The user devices 220, 222 also may enable a user to access Web sites, software, databases, etc. hosted or operated by distributors or other devices. If desired, the user devices 220, 222 also may be connected to or otherwise in communication with other devices. Possible user devices include a personal computer, portable computer, mobile or fixed user station, workstation, network terminal or server, cellular telephone, kiosk, dumb terminal, personal digital assistant, etc. In some embodiments, information regarding one or more users and/or one or more user devices may be stored in, or accessed from, a user information database and/or a user device information database.

Many different types of implementations or hardware configurations can be used in the system 150 and with the methods disclosed herein and the methods disclosed herein are not limited to any specific hardware configuration for the system 150 or any of its components.

The communications network 226 might be or include the Internet, the World Wide Web, or some other public or private computer, cable, telephone, client/server, peer-to-peer, or communications network or intranet, as will be described in further detail below. The communications network 226 illustrated in FIG. 5 is meant only to be generally representative of cable, computer, telephone, peer-to-peer or other communication networks for purposes of elaboration and explanation of the present invention and other devices, networks, etc. may be connected to the communications network 226 without departing from the scope of the present invention. The communications network 226 also can include other public and/or private wide area networks, local area networks, wireless networks, data communication networks or connections, intranets, routers, satellite links, microwave links, cellular or telephone networks, radio links, fiber optic transmission lines, ISDN lines, T1 lines, DSL, etc. In some embodiments, a user device may be connected directly to a distributor without departing from the scope of the present invention. Moreover, as used herein, communications include those enabled by wired or wireless technology.

In some embodiments, a suitable wireless communication network 226 may include the use of Blue tooth technology, allowing a wide range of computing and telecommunication devices to be interconnected via wireless connections. Specifications and other information regarding Bluetooth technology are available at the Bluetooth Internet site www.bluetooth.com. In embodiments utilizing Bluetooth technology, some or all of the devices of FIG. 5 may be equipped with a microchip transceiver that transmits and receives in a previously unused frequency band of 2.45 GHz that is available globally (with some variation of bandwidth in different countries). Connections can be point-to-point or multipoint over a current maximum range of ten (10) meters. Embodiments using Bluetooth technology may require the additional use of one or more receiving stations to receive and forward data from individual user devices, distributors, etc.

Although two user devices, one network manager, two content providers and nine distributors are shown in FIG. 5, any number of such devices may be included in the system 150. The devices shown in FIG. 5 need not be in constant communication. For example, a user device may communicate with a distributor only when such communication is appropriate or necessary.

Network Manager

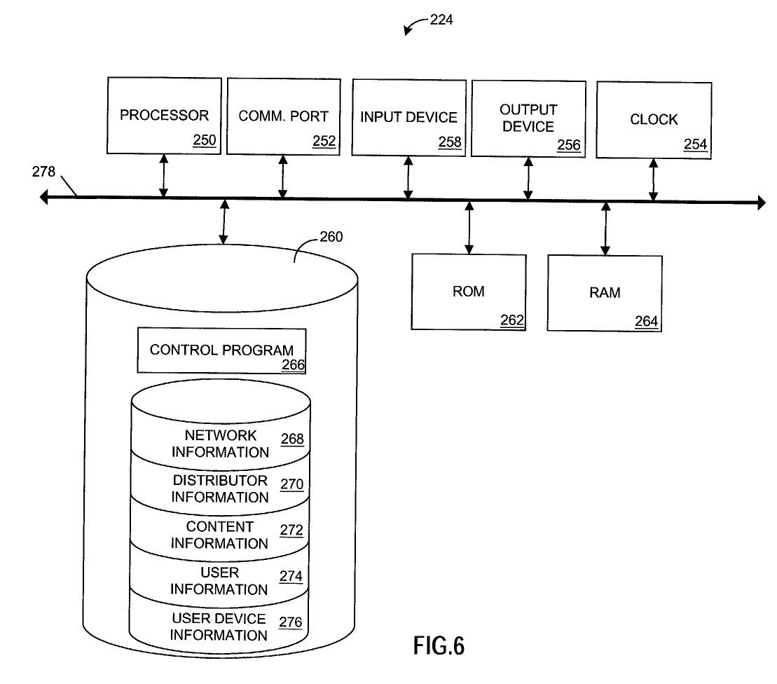

Now referring to FIG. 6, a representative block diagram of a network manager, server or controller 224 is illustrated. In some embodiments, a network manager also may act as a distributor of content.

The network manager 224 may include a processor, microchip, central processing unit, or computer 250 that is in communication with or otherwise uses or includes one or more communication ports 252 for communicating with user devices and/or other devices. Communication ports may include such things as local area network adapters, wireless communication devices, Bluetooth technology, etc. The network manager 224 also may include an internal clock element 254 to maintain an accurate time and date for the network manager 224, create time stamps for communications received or sent by the network manager 224, etc.

If desired, the network manager 224 may include one or more output devices 256 such as a printer, infrared or other transmitter, antenna, audio speaker, display screen or monitor, text to speech converter, etc., as well as one or more input devices 258 such as a bar code reader or other optical scanner, infrared or other receiver, antenna, magnetic stripe reader, image scanner, roller ball, touch pad, joystick, touch screen, microphone, computer keyboard, computer mouse, etc.

In addition to the above, the network manager 224 may include a memory or data storage device 260 to store information, software, databases, communications, device drivers, content, etc. The memory or data storage device 260 preferably comprises an appropriate combination of magnetic, optical and/or semiconductor memory, and may include, for example, Random Read-Only Memory (ROM), Random Access Memory (RAM), a tape drive, flash memory, a floppy disk drive, a Zip™ disk drive, a compact disc and/or a hard disk. The network manager 224 also may include separate ROM 262 and RAM 264.

The processor 250 and the data storage device 260 in the network manager 224 each may be, for example: (i) located entirely within a single computer or other computing device; or (ii) connected to each other by a remote communication medium, such as a serial port cable, telephone line or radio frequency transceiver. In one embodiment, the network manager 224 may comprise one or more computers that are connected to a remote server computer for maintaining databases.

A conventional personal computer or workstation with sufficient memory and processing capability may be used as the network manager 224. In one embodiment, the network manager 224 operates as or includes a Web server for an Internet environment. The network manager 224 preferably is capable of high volume transaction processing, performing a significant number of mathematical calculations in processing communications and database searches. A Pentium™ microprocessor such as the Pentium III™ microprocessor, manufactured by Intel Corporation may be used for the processor 250. Equivalent processors are available from Motorola, Inc., AMD, or Sun Microsystems, Inc. The processor 250 also may comprise one or more microprocessors, computers, computer systems, etc.

Software may be resident and operating or operational on the network manager 224. The software may be stored on the data storage device 260 and may include a control program 266 for operating the server, databases, etc. The control program 266 may control the processor 250. The processor 250 preferably performs instructions of the control program 266, and thereby operates in accordance with the present invention, and particularly in accordance with the methods described in detail herein. The control program 266 may be stored in a compressed, uncompiled and/or encrypted format. The control program 266 furthermore includes program elements that may be necessary, such as an operating system, a database management system and device drivers for allowing the processor 250 to interface with peripheral devices, databases, etc. Appropriate program elements are known to those skilled in the art, and need not be described in detail herein.

The network manager 224 also may include or store information regarding users, user devices, content segments, content providers, distributors, communications, etc. For example, information regarding one or more networks may be stored in a network information database 268 for use by the network manager 224 or another device or entity. Information regarding one or more distributors may be stored in a distributor information database 270 for use by the network manager 224 or another device or entity and information regarding content may be stored in a content information database 272 for use by the network manager 224 or another device or entity. Information regarding one or more users may be stored in a user information database 274 for use by the network manager 224 or another device or entity and information regarding one or more user devices may be stored in a user device information database 276 for use by the network manager 224 or another device or entity. In some embodiments, some or all of one or more of the databases may be stored or mirrored remotely from the network manager 224.

According to an embodiment of the present invention, the instructions of the control program may be read into a main memory from another computer-readable medium, such as from the ROM 262 to the RAM 264. Execution of sequences of the instructions in the control program causes the processor 250 to perform the process steps described herein. In alternative embodiments, hard-wired circuitry may be used in place of, or in combination with, software instructions for implementation of some or all of the methods of the present invention. Thus, embodiments of the present invention are not limited to any specific combination of hardware and software.

The processor 250, communication port 252, clock 254, output device 256, input device 258, data storage device 260, ROM 262, and RAM 264 may communicate or be connected directly or indirectly in a variety of ways. For example, the processor 250, communication port 252, clock 254, output device 256, input device 258, data storage device 260, ROM 262, and RAM 264 may be connected via a bus 278.

While specific implementations and hardware configurations for servers 204 have been illustrated, it should be noted that other implementations and hardware configurations are possible and that no specific implementation or hardware configuration is needed. Thus, not all of the components illustrated in FIG. 4 may be needed for a server implementing the methods disclosed herein. Therefore, many different types of implementations or hardware configurations can be used in the system 150 and the methods disclosed herein are not limited to any specific hardware configuration. In some embodiments, the network manager 224 also may function as a distributor and/or a content provider. All of the methods disclosed herein may be implemented by the network manager 224.

User Device

As mentioned above, a user device may be or include any of a number of different types of devices, including, but not limited to a personal computer, portable computer, mobile or fixed user station, workstation, network terminal or server, telephone, beeper, kiosk, dumb terminal, personal digital assistant, facsimile machine, two-way pager, radio, cable set-top box, etc. In some embodiments, a user device may have the same structure or configuration as the network manager 224 illustrated in FIG. 6 and include some or all of the components of the network manager 224.

Content Provider

As mentioned above, a content provider can comprise a single device or computer, a networked set or group of devices or computers, a workstation, etc. In some embodiments, a content provider may be or include any of a number of different types of devices, including, but not limited to a personal computer, portable computer, mobile or fixed user station, workstation, network terminal or server, telephone, beeper, kiosk, dumb terminal, personal digital assistant, facsimile machine, two-way pager, radio, cable set-top box, etc. In some embodiments, a content provider may have the same structure, databases or configuration as the network manager 224 illustrated in FIG. 6 and include some or all of the components of the network manager 224. In some embodiments, a content provider also may function as a network manager and/or a distributor. All of the methods disclosed herein may be implemented by a content provider.

Distributor

As mentioned above, a distributor can comprise a single device or computer, a networked set or group of devices or computers, a workstation, etc. In some embodiments, a distributor may be or include any of a number of different types of devices, including, but not limited to a personal computer, portable computer, mobile or fixed user station, workstation, network terminal or server, telephone, beeper, kiosk, dumb terminal, personal digital assistant, facsimile machine, two-way pager, radio, cable set-top box, etc. In some embodiments, a distributor may have the same structure or configuration as the network manager 224 illustrated in FIG. 6 and include some or all of the components, databases, etc. of the network manager 224. In some embodiments, a distributor also may function as a network manager and/or a content provider. All of the methods disclosed herein may be implemented by a distributor.

Databases

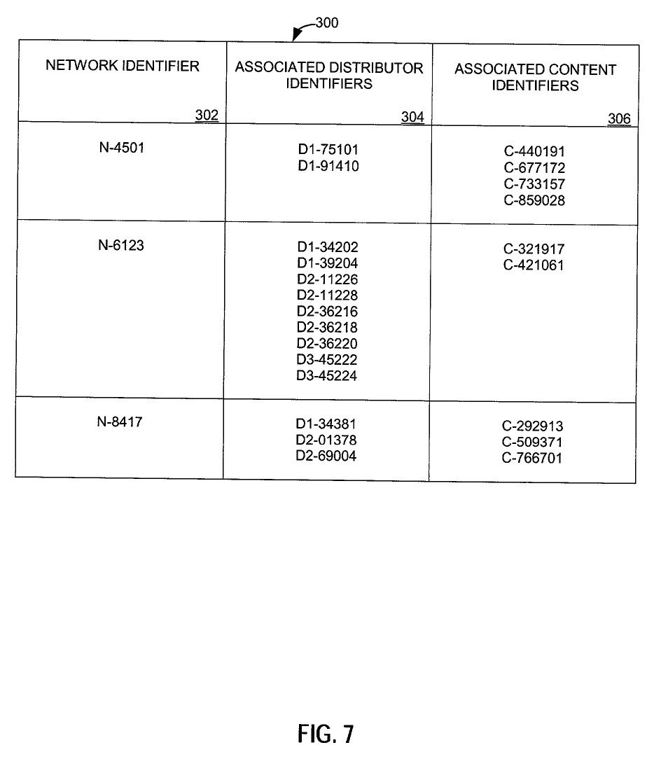

As previously discussed above, in some embodiments a server, user device, or other device may include or access a network information database for storing or keeping information regarding one or more networks. One representative network information database 300 is illustrated in FIG. 7.

The network information database 300 may include a network identifier field 302 that may include codes or other identifiers for one or more networks, an associated distributor identifier field 304 that may include codes or other identifiers for one or more distributors associated with or forming part of the networks identified in the field 302, and an associated content provider identifier field 306 that may include codes or other identifiers for one or more portions content associated with the networks identified in the field 302. Other or different fields also may be used in the network information database 300. For example, in some embodiments a network information database may include one or more fields that contain information regarding operational status, configuration, load, availability, etc. of a network, a distributor in the network, etc.

As illustrated by the network information database 300 of FIG. 7, the network identified as “N-4501” in the field 302 includes two distributors identified as “D1-75101” and “D1-91410” in the field 304. The designation “D1” may indicate that the distributors are tier one level distributors with reference to the network “N-4501”. In some embodiments, a distributor may be associated with more than one network. Additional information regarding a distributor in a network may be found in distributor information database. The network identified as “N-4501” in the field 302 is associated with the content portions identified as “C-440191”, “C-677172”, “C-733157” and “C-859028” in the field 306, presumably indicated that this content is or can be distributed via the network identified as “N-4501”. In some embodiments, information regarding content may be found in a content information database.

As illustrated in the network information database 300 of FIG. 7, the network identified as “N-6123” includes nine distributors “D1-34202”, “D1-39024”, “D2-11226”, “D2-11228”, “D2-36216”, “D2-36218”, “D2-36220”, “D3-45222” and “D3-45224”. The network identified as “N-6123” also provides or distributes the content “C-321917” and “C-421061”.

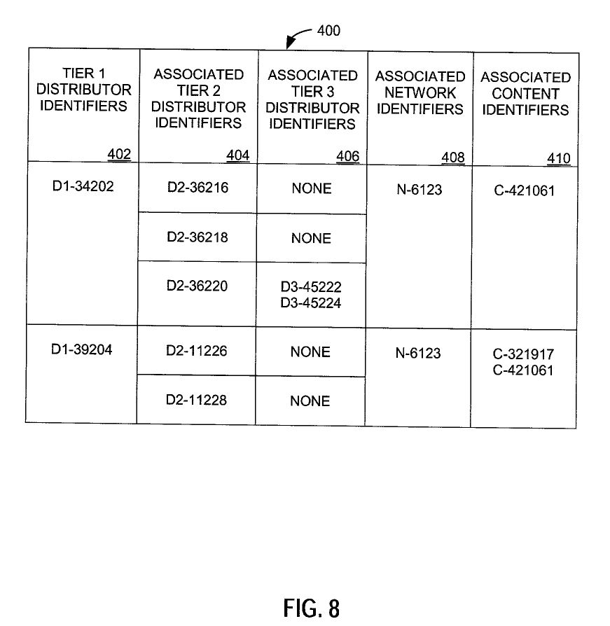

As previously discussed above, in some embodiments a server, user device, or other device may include or access a distributor information database for storing or keeping information regarding one or more distributors. One representative distributor information database 400 is illustrated in FIG. 8.

The distributor information database 400 may include a tier one distributors identifier field 402 that may include codes or other identifiers for one or more tier one level distributors, an a tier two distributors identifier field 404 that may include codes or other identifiers for one or more tier two level distributors associated with the tier one distributors identified in the field 402, a tier three distributors identifier field 406 that may include codes or other identifiers for one or more tier two level distributors identified in the field 404, an associated network identifier field 408 that may include codes or other identifiers for one or more networks to which the distributors identified in the field 402 are associated, and a content identifier field 410 that may include codes or other identifiers for one or more content packages distributed by the distributors identified in the fields 402, 404 and 406.

Other or different fields also may be used in the distributor information database 400. For example, in some embodiments, a distributor information database may include fields that include information regarding the location, availability, storage capacity, bandwidth, electronic address, configuration, etc. of the distributors, fields that include information regarding names, descriptions, etc of the distributors; fields that include information regarding number of content deliveries, number of bytes transferred, number of bytes stored, descriptions of content stored, benefits received, etc. by the distributors, etc. A distributor may be associated with one or more networks, and vice versa.

As illustrated by the distributor information database 400 of FIG. 8, the tier one distributor identified as “D1-34202” in the field 402 is associated and in communication with three tier two distributors “D2-36216”, “D2-36218” and “D2-36220”. The tier two distributor “D2-36220”, and hence the tier one distributor “D1-34202”, are associated and in communication with two tier three distributors “D3-45222” and “D3-45224”. The distributors “D1-34202”, D2-36216”, “D2-36218”, “D2-36220”, “D3-45222” and “D3-45224” are all part of the network “N-6123” and provide distribution of the content identified as “C-421061”. The distributor information database 400 of FIG. 8 provides a tabular description of the distribution network 150 of FIGS. 2 and 5.

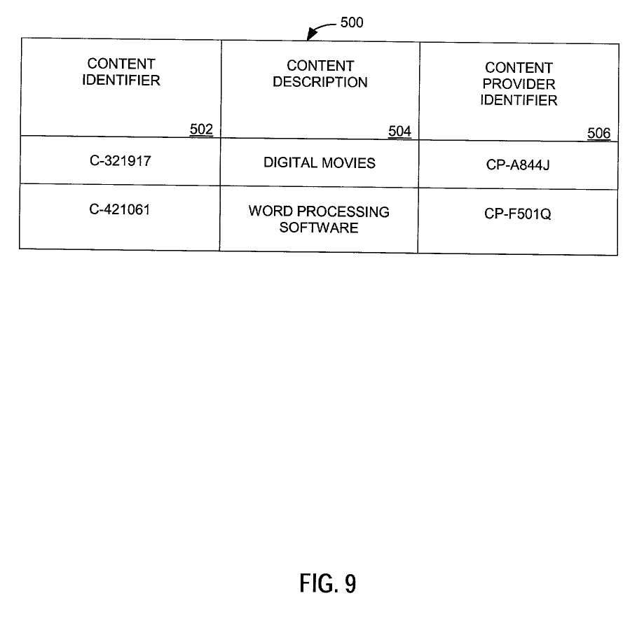

As previously discussed above, in some embodiments a server, user device, or other device may include or access a content information database for storing or keeping information regarding one or more content packages. One representative content information database 500 is illustrated in FIG. 9.

The content information database 500 may include a content identifier field 502 that may include codes or other identifiers for one or more content packages, programs, units, etc., a content description field 504 that may include names, descriptions or other information regarding the content identified in the field 502, and a content provider identifier field 506 that may include codes or other identifiers for one or more providers of the content identified in the field 502.

Other or different fields also may be used in the content information database 500. For example, in some embodiments a content information database may include pricing retail and/or wholesale pricing information, information regarding operational or technical requirements or capabilities of the content identified in the field 502, etc.

As illustrated by the content information database 500 of FIG. 9, the content identified as “C-421061” is “WORD PROCESSING SOFTWARE” and is provided by the content provider identified as “CP-F501Q” in the field 506. In some embodiments, information regarding one or more content providers may be found in a content provider information database.

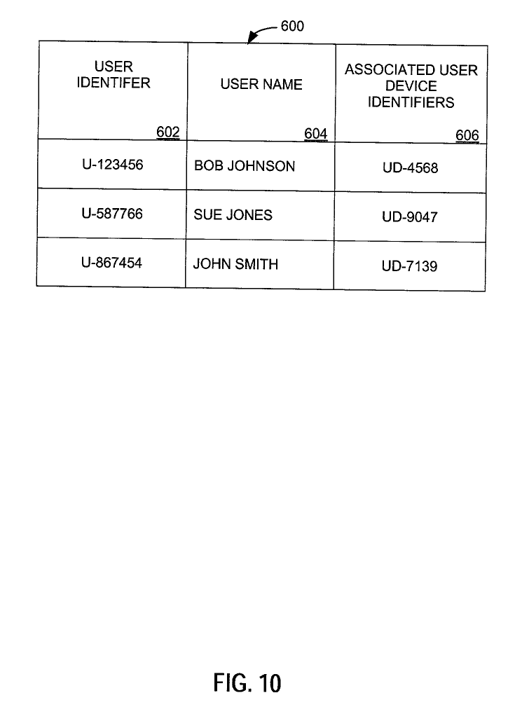

As previously discussed above, in some embodiments a server, user device, or other device may include or access a user information database for storing or keeping information regarding one or more users who may purchase or receive content via a distribution network. One representative user information database 600 is illustrated in FIG. 10.

The user information database 600 may include a user identifier field 602 that may include codes or other identifiers for one or more users, a user name field 604 that may include names for the users identified in the field 602 and an associated user device identifier field 606 that may include codes or other identifiers for devices associated with the users identified in the field 602. Other or different fields also may be used in the user information database 600. For example, in some embodiments a user information database may include address, telephone number, email address, postal address or other contact information for the users identified in the field 602, information regarding credit history, financial accounts, or credit card information for the users identified in the field 602, etc.

As illustrated by the user information database 600 of FIG. 10, the user identified as “U-123456” in the field 602 is named “BOB JOHNSON” and is associated with the user device identified as “UD-4568”. In some embodiments, information regarding one or more user devices may be found in a user device information database. A user may be associated with one or more user device, and vice versa.

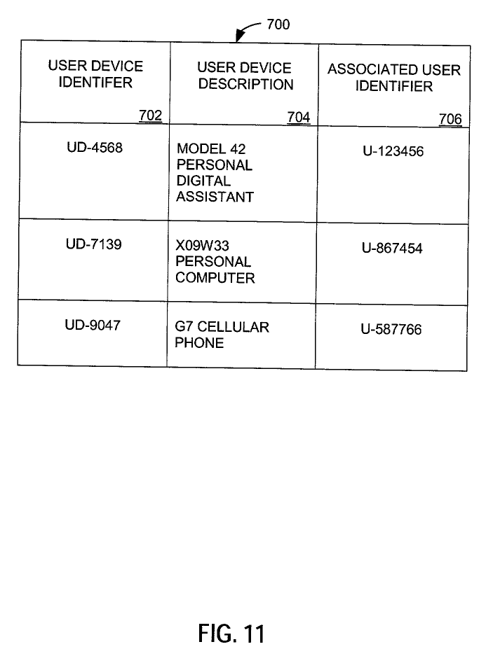

As previously discussed above, in some embodiments a server, user device, or other device may include or access a user device information database for storing or keeping information regarding one or more user devices. One representative user device information database 700 is illustrated in FIG. 11.

The user device information database 700 may include a user device field 702 that may include codes or other identifiers for one or more user devices, a user device description field 704 that may include names, descriptions, model numbers, etc. for the user devices identified in the field 702 and an associated user identifier field 706 that may include codes or other identifiers for users associated with the user devices identified in the field 702.

Other or different fields also may be used in the user device information database 700. For example, in some embodiments a user device information database may include information regarding status, operational capabilities (e.g., storage capacity, display capabilities), availability, etc. of the user devices identified in the field 702.

As illustrated by the user device information database 700 of FIG. 11, the user device identified as “UD-4568” in the field 702 is a “MODEL 42 PERSONAL DIGITAL ASSISTANT” and is associated with the user identified as “U-123456” in the field 706.

The methods of the present invention may be embodied as a computer program developed using an object oriented language that allows the modeling of complex systems with modular objects to create abstractions that are representative of real world, physical objects and their interrelationships. However, it would be understood by one of ordinary skill in the art that the invention as described herein could be implemented in many different ways using a wide range of programming techniques as well as general-purpose hardware systems or dedicated controllers. In addition, many, if not all, of the steps for the methods described above are optional or can be combined or performed in one or more alternative orders or sequences without departing from the scope of the present invention and the claims should not be construed as being limited to any particular order or sequence, unless specifically indicated.

Each of the methods described above can be performed on a single computer, computer system, microprocessor, etc. In addition, two or more of the steps in each of the methods described above could be performed on two or more different computers, computer systems, microprocessors, etc., some or all of which may be locally or remotely configured. The methods can be implemented in any sort or implementation of computer software, program, sets of instructions, code, ASIC, or specially designed chips, logic gates, or other hardware structured to directly effect or implement such software, programs, sets of instructions or code. The computer software, program, sets of instructions or code can be storable, writeable, or savable on any computer usable or readable media or other program storage device or media such as a floppy or other magnetic or optical disk, magnetic or optical tape, CD-ROM, DVD, punch cards, paper tape, hard disk drive, Zip™ disk, flash or optical memory card, microprocessor, solid state memory device, RAM, EPROM, or ROM.

Although the present invention has been described with respect to a preferred embodiment thereof, those skilled in the art will note that various substitutions may be made to those embodiments described herein without departing from the spirit and scope of the present invention.

The words “comprise,” “comprises,” “comprising,” “include,” “including,” and “includes” when used in this specification and in the following claims are intended to specify the presence of stated features, elements, integers, components, or steps, but they do not preclude the presence or addition of one or more other features, elements, integers, components, steps, or groups thereof.

The embodiments of the invention in which an exclusive property or privilege is claimed are defined as follows:

1. A method for establishing a distribution network, comprising:
establishing a first distributor of content capable of distributing said content via transmission of an electronic signal; and
providing a first benefit to said first distributor as a result of said first distributor establishing a second distributor of said content.

2. The method of claim 1, wherein said establishing a first distributor of content capable of distributing said content via transmission of an electronic signal includes at least one of the following:
providing a notification of availability of said benefit to said first distributor;
receiving a request from said first distributor to act as a distributor of said content;
registering said first distributor as part of a distribution network for said content;
receiving approval from a provider of said content to allow said first distributor to act as a distributor of said content;
granting a license to said first distributor to act as a distributor of said content; and
providing data to said first distributor indicative of said benefit.

3. The method of claim 1, further comprising:
providing said content to said first distributor.

4. The method of claim 3, wherein said providing said content to said first distributor includes at least one of the following:
emailing said content to said first distributor;
instructing another distributor in said network to provide said content to said first distributor;
allowing said first distributor to retrieve said content;
providing data to said first distributor indicative of a location where said content is located;
providing data to said first distributor indicative of a location where said content can be retrieved by said first distributor;
providing a key to said first distributor that enables use of said content; and
providing a key to said first distributor that enables decryption of said content.

5. The method of claim 1, wherein said providing a first benefit to said first distributor includes at least one of the following:
providing an indication to said first distributor of said first benefit;
applying the first benefit during a transaction involving said first distributor;
providing an instruction to a party to provide said first benefit to said first distributor; and
providing instructions to said first distributor regarding how said first distributor can receive said first benefit.

6. The method of claim 1, further comprising:
providing said first distributor with a second benefit as a result of said second distributor establishing a third distributor of said content.

7. The method of claim 6, further comprising:
providing said second distributor with a benefit as a result of said second distributor establishing a third distributor of said content.

8. The method of claim 6, wherein said third distributor receives said content from said first distributor.

9. The method of claim 6, wherein said third distributor receives said content from said second distributor.

10. The method of claim 1, wherein said second distributor is capable of distributing said content via transmission of an electronic signal.

11. The method of claim 1, wherein said content is in electronic format.

12. The method of claim 1, wherein said content includes at least one of the following:
educational information;
an advertisement;
a survey;
a question;
an animation;
a sound file;
a music file;
a real-time feed of information;
streaming video;
streaming audio;
a movie file;
software;
a video clip;
a multimedia file;
an image;
text material; and
rich media.

13. The method of claim 1, wherein said first benefit is based, at least in part, on at least one of the following:
an amount per distribution of said content by said first distributor to another distributor;
an amount per distribution of said content by said second distributor;
an amount of content distributed by said second distributor;
an type of content distributed by said second distributor;
storage capacity of said second distributor;
physical location of said second distributor;
availability of said second distributor; and
amount of access of said second distributor by potential recipients of said content.

14. The method of claim 1, wherein said first benefit is based, at least in part, on at least one of the following:
an amount of content distributed by said first distributor;
a type of content distributed by said first distributor;
storage capacity of said first distributor;
physical location of said first distributor;
availability of said first distributor;
amount of access of said first distributor by potential recipients of said content; and
an amount per distribution of said content by said first distributor to a recipient of said content.

15. The method of claim 1, further comprising:
allowing said first distributor to provide said content to said second distributor.

16. The method of claim 1, further comprising:
receiving said content.

17. The method of claim 1, wherein said first distributor is part of a network of at least one distributor for said content.

18. The method of claim 1, wherein said first benefit includes at least one of the following:
a monetary amount;
a discount applicable towards purchase of said content;
a discount applicable towards a cost of a license to use said content;
a non-monetary amount;
a coupon; and
frequent flyer miles.

19. The method of claim 1, further comprising:
providing to said first distributor an indication of a desired attribute for a new distributor of said content.

20. The method of claim 1, further comprising:
determining at least one desired attribute for a new distributor of said content.

21. The method of claim 1, further comprising:
determining at least one attribute of said content.

22. The method of claim 1, further comprising:
notifying said first distributor of an availability of said first benefit prior to said establishing a first distributor of content.

23. The method of claim 1, further comprising:
notifying said first distributor of an availability of said first benefit prior to said providing a benefit to said first distributor as a result of said first distributor establishing a second distributor of said content.

24. The method of claim 1, further comprising:
providing said content to said second distributor.

25. The method of claim 1, further comprising:
receiving a notification from said first distributor that said first distributor has established said second distributor.

26. The method of claim 1, further comprising:
monitoring performance of said first distributor.

27. The method of claim 1, further comprising:
monitoring performance of said second distributor.

28. The method of claim 1, further comprising at least one of the following:
receiving a payment for said content from a recipient of said content;
receiving a payment for said content from said first distributor; and
receiving a payment for said content from said second distributor.

29. A method for participating in a distribution network, comprising:
establishing at least one distributor of content; and
receiving a benefit based, at least in part, on said establishing at least one distributor of said content.

30. The method of claim 29, further comprising:
receiving said content.

31. The method of claim 30, wherein said receiving said content includes at least one of the following:
receiving said content via transmission of an electronic signal;
receiving said content via transmission of a wireless signal;
receiving said content from another distributor of said content;
receiving data indicative of a location where said content is located;
receiving data indicative of a location from which said content is retrievable; and
receiving a key that enables decryption of said content.

32. The method of claim 29, wherein said establishing at least one distributor of said content includes at least one of the following:
receiving a request from a party to act as a distributor of said content;
registering said at least one distributor as part of a distribution network for said content;
receiving approval from a provider of said content to allow said at least one distributor to act as a distributor of said content;
granting a license to said at least one distributor to act as a distributor of said content; and
providing data to said at least one distributor indicative of said benefit.

33. The method of claim 29, further comprising:
providing an identifier of said content to said at least one distributor.

34. The method of claim 29, further comprising:
providing said content to said at least one distributor.

35. The method of claim 34, wherein said providing said content to said at least one distributor includes at least one of the following:
instructing another distributor in said network to provide said content to said at least one distributor;
allowing said at least one distributor to retrieve said content;
providing data to said at least one distributor indicative of a location where said content is located;
providing a key to said at least one distributor that enables use of said content; and
providing a key to said at least one distributor that enables decryption of said content.

36. The method of claim 29, wherein said receiving a benefit based, at least in part, on said establishing at least one distributor of said content includes at least one of the following:
receiving an indication of a location of said benefit;
receiving a description of said benefit; and
receiving instructions how to receive said benefit.

37. The method of claim 29, further comprising:
providing to said at least one distributor an indication of a desired attribute for a new distributor of said content.

38. The method of claim 29, further comprising:
determining at least one desired attribute for a new distributor of said content.

39. The method of claim 29, further comprising:
determining at least one attribute of said content.

40. The method of claim 29, further comprising:
receiving data indicative of at least one desired attribute for a new distributor of said content.

41. The method of claim 29, further comprising:
receiving a notification indicative of availability of said benefit.

42. The method of claim 29, further comprising:
providing a notification upon said establishing at least one distributor of said content that said at least one distributor has been established.

43. The method of claim 29, further comprising:
monitoring performance of said at least one distributor.

44. The method of claim 29, further comprising:
receiving payment for said content from a recipient of said content.

45. The method of claim 29, further comprising:
receiving payment for said content from said at least one distributor.

46. The method of claim 29, further comprising:
providing payment for said content to another party.

47. The method of claim 29, wherein said content is in an electronic format.

48. A method for maintaining a distribution network, comprising:
determining a requirement of a network for distribution of content, wherein said content is in electronic form and said network includes at least one distributor of said content;
determining at least one desired attribute for a distributor of said content, wherein said attribute is based, at least in part, on said requirement; and
providing an indication of said desired attribute.

49. The method of claim 48, wherein said requirement includes at least one of the following:
a current requirement for said network to respond to requests for said content;
a current requirement for said network to provide said content to at least one recipient;
a current requirement for said network to store said content;
a future requirement for said network to respond to requests for said content;
a future requirement for said network to provide said content to at least one recipient;
a future requirement for said network to store said content;
a current minimum delivery requirement associated with said content;
a current minimum storage requirement associated with said content;
an expected minimum delivery requirement associated with said content; and
an expected minimum storage requirement associated with said content.

50. The method of claim 48, wherein said requirement includes at least one of the following:
a minimum level of ability of a distributor in said network to transmit said content;
a minimum level of ability of a distributor in said network to store said content;
a minimum percentage of availability of a distributor in said network;
a minimum amount of accessibility of a distributor in said network of said content by a potential recipient of said content;
a minimum storage capability of a distributor in said network;
a specific physical location of a distributor in said network;
a specific topological location of a distributor in said network;
a specific configuration of hardware used by a distributor in said network of said content;
a minimum transmission capability of a distributor in said network;
a minimum satisfaction level associated with at least one recipient of said content from a distributor in said network;
a minimum level of ability by a distributor in said network to respond to requests from potential recipients of said content; and
a minimum number of distributions of said content by a distributor in said network.

51. The method of claim 48, wherein said determining at least one desired attribute for a distributor of said content includes at least one of the following:
determining an attribute that will help said network meet said requirement if a distributor having said attribute is added to said network; and
determining an attribute that will help said network meet said requirement if a distributor already in said network develops said attribute.

52. The method of claim 48, wherein said attribute includes at least one of the following:
an affiliation with a designated organization;
a minimum mobility characteristic;
a minimum processing capability;
a designated hardware configuration;
a designated software configuration;
a minimum reliability level;
a minimum operational characteristic;
a minimum availability to a potential recipient of said content;
a minimum accessibility by a potential recipient of said content;
a minimum storage capability;
a physical location;
a topological location;
a minimum transmission capability; and
a minimum bandwidth.

53. The method of claim 48, further comprising:
providing a benefit to a distributor in said network that develops said attribute.

54. The method of claim 48, further comprising:
providing a benefit to a party that establishes a distributor in said network that has said attribute.

55. The method of claim 48, further comprising:
providing a notification of a benefit available to a party that establishes a distributor in said network that has said attribute.

56. A system for establishing at least one distributor of content, comprising:
a memory;
communication port; and
a processor connected to said memory and said communication port, said processor being operative to:
establish a first distributor of content capable of distributing said content via transmission of an electronic signal; and
provide a benefit to said first distributor as a result of said first distributor establishing a second distributor of said content.

57. A system for establishing at least one distributor of content, comprising:
a memory;
communication port; and
a processor connected to said memory and said communication port, said processor being operative to:
establish a distributor of content capable of distributing said content via transmission of an electronic signal; and
receive a benefit as a result of said establishing a distributor of said content.

58. A computer program product in a computer readable medium for rewarding a distributor of content, comprising:
first instructions for determining a first distributor of content capable of distributing said content via transmission of an electronic signal; and
second instructions for sending a first benefit to said first distributor as a result of said first distributor establishing a second distributor of said content.
